(19) United States
(12) Patent Application Publication
(10) Pub. No.: US 2026/0317507 A1
(43) Pub. Date: Oct. 15, 2026

(54) SHEARING PROCESS FOR IMPROVING PHASE STABILITY OF RECYCLATE POLYOL DISPERSIONS

(71) Applicants: DOW SILICONES CORPORATION, Midland, MI (US); DOW GLOBAL TECHNOLOGIES LLC, Midland, MI (US)

(72) Inventors: Craig F. GORIN, Auburn, MI (US); Daniel L. DERMODY, Midland, MI (US); Thomas L. TOMCZAK, Midland, MI (US); En WANG, Midland, MI (US); Kaoru AOU, Lake Jackson, TX (US); Justin WALKER, Midland, MI (US); Hans KRAMER, Kempraten-Jona (CH); Sven CLAESSENS, Terneuzen (NL)

(21) Appl. No.: 19/485,927

(22) PCT Filed: Dec. 18, 2023
(86) PCT No.: PCT/US2023/084604

§ 371 Date: Nov. 19, 2025

Related U.S. Application Data
(60) Provisional application No. 63/505,073, filed on May 31, 2023.

(51) Int. Cl. C08J 11/28

(52) U.S. Cl. CPC C08J 11/28

(57) ABSTRACT

The phase stability of a recyclate polyol dispersion is improved by shearing the dispersion, using a rotor/stator or other suitable device. After shearing, the recyclate polyol dispersion exhibits a lower Lumisizer Instability Index (indicating improved phase stability). The improved phase stability results in easier storage, transportation and use of the recyclate polyol dispersion. An embodiment of a method for stabilizing a starting recyclate polyol dispersion that exhibits a Lumisizer Instability Index of at least 0.60, comprises shearing the starting recyclate polyol dispersion at a mean shear rate of at least 5,500/s for a period of time sufficient (e.g., 0.05 to 5 seconds) to produce a stabilized recyclate polyol dispersion (e.g., exhibiting a Lumisizer Instability Index of at most 0.55). Other related methods are also disclosed herein.

This invention relates to recyclate polyol dispersions and methods for improving their phase stability.

Polyurethanes can be decomposed into useful polyol products via various chemolysis processes. Examples of chemolysis processes include hydrolysis, acidolysis and glycolysis processes, in which water, carboxylic acids (or, equivalently, carboxylic acid anhydrides) and “virgin” polyol are used, respectively, as reagents. The chemolysis process frequently includes glycolysis together with hydrolysis and/or acidolysis, which can be done simultaneously, sequentially, or partially simultaneously and partially sequentially. The product of the chemolysis process is typically a dispersion having a liquid polyol phase that include “recyclate” polyols, i.e., liquid polyols that are products of the decomposition reactions, and a disperse phase that includes solid oligomeric decomposition products in the form of small particles. The liquid polyol phase formed in glycolysis processes typically contains virgin polyol in addition to the recyclate polyol. Dispersions produced in these chemolysis processes have been shown to be useful in making both rigid and flexible polyurethane foams.

A problem with these dispersions is they tend to be unstable. Over time the dispersed solids tend to settle in storage and transportation equipment, and even in the lines and mixhead of foam production equipment. This leads to various problems, such as inconsistencies in the composition of the dispersions, inconsistencies in foam products made using the dispersions, and fouled equipment. A way to stabilize the dispersions to reduce settling is desired. Such a solution preferably does not interfere with a polyurethane foaming process that makes use of the dispersion, and also preferably does not lead to significant adverse effects when the dispersion is used to make polyurethane foam.

The invention is a method for stabilizing a starting recyclate polyol dispersion that exhibits a Lumisizer Instability Index of at least 0.60, comprising shearing the starting recyclate polyol dispersion at a mean shear rate of at least 5500/s for a period of time sufficient to produce a stabilized recyclate polyol dispersion exhibiting a Lumisizer Instability Index of at most 0.55.

The invention is also method for stabilizing a starting recyclate polyol dispersion that exhibits a Lumisizer Instability Index of at least 0.60, comprising shearing the starting recyclate polyol dispersion for a period 0.05 to 10 seconds at a mean shear rate of at least 5500/s.

The invention is also a method for stabilizing a starting recyclate polyol dispersion that exhibits a Lumisizer Instability Index of at least 0.60, comprising shearing the starting recyclate polyol dispersion in a shearing apparatus under conditions that provide at least 104 watts of power per kg of the starting recyclate material, for a period of time sufficient to produce a stabilized recyclate polyol dispersion exhibiting a Lumisizer Instability Index of at most 0.55.

Surprisingly, shearing a recyclate polyol dispersion has been found to dramatically improve its phase stability.

As used herein, a “recyclate polyol dispersion” is a mixture of (i) liquid polyols and (ii) dispersed particles containing one or more urethane, urea and/or imide groups, that is produced in a chemolytic decomposition of a polyurethane and/or polyurea polymer. The liquid polyols include polyols regenerated from the polyurethane and/or polyurea polymer in the chemolysis reaction (“recyclate polyols”), and usually further include “virgin” polyols. “Virgin” polyols are polyols added into the chemolysis process, and do not include the polyurethane and/or polyurea polymers or polyols produced by the chemolysis thereof. The dispersed particles containing one or more of urethane, urea and/or imide groups are also materials generated in the chemolysis of the polyurethane and/or polyurea polymer.

The liquid polyols may constitute, for example, 10 to 100%, especially 20 to 60% by weight of recyclate polyols and correspondingly 0 to 90%, especially 40 to 80% by weight virgin polyols. The liquid polyols may include, for example a virgin polyether polyol having a number average molecular weight of 400 to 16,000 g/mol, especially 400 to 4,000 g/mol (by gel permeation chromatography against polystyrene standards) and a hydroxyl functionality of 2 to 8, 2 to 6 or 2 to 4. The recyclate polyol also may include one or more polyether polyols that have similar molecular weights and hydroxyl functionalities.

Alternatively or in addition, the liquid polyols may include short-chain diols and/or triols having formula molecular weights of up to 250 g/mol or up to 150 g/mol, including, for example, one or more of ethylene glycol, diethylene glycol, propylene glycol, dipropylene glycol, glycerin, trimethylolpropane, triethylolpropane and the like. The short-chain diols and/or triols may include both virgin materials and diols and/or triols formed in the chemolysis reaction.

The dispersed particles may constitute, for example, 1 to 60%, preferably 5 to 60% or 10 to 50% of the total weight of the starting recyclate polyol dispersion. In some embodiments, at least a portion of the dispersed particles include imide groups. Imide groups can be formed, for example, by including an imide precursor as described more fully below in the chemolysis process. The dispersed particles typically have particle sizes (D90) of up to 50 μm (i.e., 90 volume-percent of the particles have particle sizes of 50 μm or less) as measured by laser diffraction, such as according to ASTM E3340. The dispersed particles are insoluble in the liquid polyols and are not grafted or otherwise chemically bonded to the liquid polyols.

The starting recyclate polyol dispersion exhibits a Lumisizer Instability Index (or “Instability Index” for short) of at least 0.60. The Instability Index of the starting recyclate polyol dispersion may be at least 0.65, at least 0.70 or at least 0.75. Lower Instability Index values indicate greater stability, i.e., less particle settling. Instability Index is determined according to ISO 13318-2 (2007) or equivalent method. Instability Index can be determined using a LUMiSizer 6110-77 instrument (LUM GmbH) by centrifuging the material for 5 hours at a rate of 4000 rpm. A software package supplied by the same vendor (SEPView Explorer, LUM GmbH) can be used to calculate Instability Index.

The starting recyclate polyol dispersion in some embodiments has a hydroxyl number (per ASTM D4274 D) of 20 to 650 mg KOH/g, especially 25 to 500 mg KOH/g; a total basicity (ASTM D6979) of 1 milliequivalent per gram or lower, especially 0.5 milliequivalent per gram or lower; and an acid number (DIN53402) of 20 mg KOH/g or lower, especially 5 mg KOH/g or lower. The stabilized recyclate polyol dispersion typically has similar hydroxyl and acid numbers as the starting recyclate polyol dispersion.

By “chemolysis” or “chemolytic decomposition”, it is meant a decomposition of a polyurethane and/or polyurea polymer by chemical means. Included within “chemolysis” are so-called “glycolysis”, wherein a polyol is reacted with the polyurethane and/or polyurea polymer to decompose the polymer; hydrolysis, wherein water is a reagent that decomposes the polymer; acidolysis, wherein a Bronsted acid, particularly a diacid (such as a dicarboxylic acid or, equivalently, a carboxylic acid anhydride) is used as a decomposition agent, and aminolysis, wherein a primary or secondary amine compound is a decomposition agent. A chemolysis may include more than one of these decomposition methods. For example, glycolysis and acidolysis, glycolysis and hydrolysis, glycolysis and aminolysis, glycolysis, acidolysis and hydrolysis or even glycolysis, acidolysis, aminolysis and hydrolysis may be performed on the polyurethane and/or polyurea polymer to produce the recyclate polyol dispersion.

Chemolysis processes for producing the starting recyclate polyol dispersion are well-known. An alcoholysis (sometimes referred to as “glycolysis”) process is described, for example, in U.S. Pat. No. 2,937,151. An acidolysis process is described in U.S. Pat. No. 3,109,824. An aminolysis process is described in U.S. Pat. No. 3,404,103. Any of these processes are suitable for producing a starting recyclate polyol dispersion for use in this invention.

Other suitable chemolysis processes include those described in U.S. Pat. No. 5,357,006, wherein a monofunctional glycidyl ether is added into a glycolysis process to reduce the amine number of the recyclate polyol dispersion, and in U.S. Pat. No. 5,763,692, wherein a cyclic carbonate is added into the glycolysis process to the same effect. It is believed the monofunctional glycidyl ether and cyclic carbonate react with amine groups on the dispersed particles produced by the glycolytic decomposition to “cap” the chain ends.

An especially preferred chemolysis process is a glycolysis/acidolysis process in which the polyurethane and/or polyurea polymer is reacted with both a polyol and an imide precursor to produce the recyclate polyol dispersion. An example of such a process is described in U.S. Pat. No. 11,124,623. In that process, a polyurethane and/or polyurea polymer is reacted with an imide precursor and a polyether polyol having a number average molecular weight (by gel permeation chromatography) of 400 to 6000 g/mol and a hydroxyl functionality of 2 to 4 in a first reaction step, and then with a short-chain diol or triol (formula molecular weight 250 g/mol or less, preferably 150 g/mol or less) in a second reaction step to produce the recyclate polyol dispersion. An “imide precursor” is a material that reacts during the chemolysis process to produce imide groups on the dispersed solid particles that are produced in the chemolysis reaction, generally through reaction with primary amino groups. Imide precursors include compounds having two or more carboxyl groups, wherein at least one pair of carboxyl groups are in the 1,2-positions relative to each other, as well as the corresponding carboxylic acid anhydrides. The imide precursor may be, for example, maleic acid, malic acid, phthalic acid, adipic acid, succinic acid, glutaric acid, di- and/or tetrahalogenated phthalic acid, trimellitic acid, and any one or more of their corresponding anhydrides. Imide-containing particles are produced in this process. Reaction temperatures may be in the range of 170 to 210° C. in the first step and 180 to 230° C. in the second step. The glycolysis/acidolysis is catalyzed by performing the reaction in the presence of a free radical initiator such as a peroxide compound, perester compound, or azo compound.

The starting polyurethane and/or polyurea polymer is characterized by having urethane groups, urea groups, or both urethane and urea groups. It may contain other groups formed by reactions of isocyanates, such as biuret, carbodiimide, allophonate, isocyanurate and the like. A preferred polyurethane and/or polyurea polymer includes polyether chains, especially chains of homopolymerized 1,2-propylene oxide, homopolymerized ethylene oxide, homopolymerized 1,2- and/or 2,3-butylene oxide, homopolymerized tetrahydrofuran or copolymers (random and/or block, for examples) of any two or more of ethylene oxide, 1,2-propylene oxide, 1,2-or 2,3-butylene oxide and tetrahydrofuran. The polyurethane and/or polyurea polymer may be non-cellular, microcellular, or cellular.

Preferably, the polyurethane and/or polyurea polymer is or includes post-consumer waste and/or scrap polyurethane such as scrap from a polyurethane foam manufacturing facility or a facility that fabricates polyurethane foam into consumer products. Most preferably, the polyurethane and/or polyurea polymer is or includes post-consumer or scrap flexible polyurethane foam. Discarded mattresses are an abundant source of post-consumer flexible polyurethane foam for use in producing the recyclate polyol dispersion. Typically, the polyurethane and/or polyurea polymer is cut into small pieces for chemolysis.

In one aspect of the invention, the starting recyclate polyol dispersion is stabilized by shearing it at a mean shear rate of at least 5,500/s. The mean shear rate may be at least 10,000/s or at least 15,000/s and may be, for example, up to 100,000/s, up to 75,000/s or up to 50,000/s. The minimum shear rate during the shearing step preferably is at least 3,000/s, provided that the mean shear rate is at least 5,500/sec. The time for which the starting recyclate polyol dispersion is subjected to the foregoing shearing conditions may be, for example, at least 0.05 second or at least 0.1 second and may be, for example, up to 10 seconds, up to 5 seconds, up to 1 second or up to 0.5 second. More generally, shearing is continued at such a shear rate for a period of time sufficient to produce a stabilized recyclate polyol dispersion exhibiting a Lumisizer Instability Index of at most 0.55, preferably at most 0.50 or at most 0.45. The shear work performed (a unitless value) on the starting recyclate dispersion may be, for example, at least 1200, at least 1500, and may be, for example, up to 50,000, up to 25,000 or up to 12,000. Shearing can be performed in various types of apparatus capable of producing the necessary shear, including, for example, rotor/stator types as are sold by IKA Works, Inc. (Wilmington, Delaware US), Silverson Machines, Ltd. (Chesham, England); sonic and ultrasonic mixers such as Sonolator® (Sonic Corporation, Stratford CT, USA) and the UIP series of ultrasonicators sold by Hielscher Ultrasonics GmbH (Teltow, Germany), milling devices such as bead mills (as described in WO2004/020532) and the like. Temperatures at or around room temperature, such as from 15° C. to 35° C., are entirely suitable, although elevated temperatures of, for example, >35° C. to 80° C. can be used.

In another aspect of the invention, the starting recyclate polyol dispersion is sheared in a shearing apparatus such as an ultrasonicator under conditions that provide at least 104 watts of power to the starting recyclate material per kg of the starting recyclate material, for a period of time sufficient to produce a stabilized recyclate polyol dispersion exhibiting a Lumisizer Instability Index of at most 0.55.

The shearing step preferably is performed in the absence of a fumed silica having a methanol wettability of methanol wettability of 10% to 60%. Methanol wettability is measured by weighing 0.2 g fumed silica and adding it into 20 g deionized water, which is then stirred on a high-speed laboratory mixer for 1 minute. The mixture is then examined visually to see whether the fumed silica is dispersed homogeneously in the liquid. If so, methanol wettability is 0. If not, methanol is added in increments, increasing the proportion of methanol in the methanol/water mixture by 5 weight-% with each increment (i.e., to 5/95, 10/90, 15/85, etc.). After each increment of methanol is added, the mixture again is stirred on the high-speed laboratory mixer for 1 minute, followed by visual examination for homogeneity. The lowest weight percentage of methanol that produces a homogeneous dispersion on this test is the methanol wettability value. The shearing step may be performed in the absence of fumed silica of any type.

The resulting stabilized recyclate polyol dispersion preferably is phase stable for at least 1 month, more preferably at least 3 months, at 23° C. and preferably also is phase stable for at least one week at 50° C. Phase stability is evaluated by allowing a sample to sit under quiescent conditions (i.e., without agitation) at the indicated temperature for the indicated time. The recyclate polyol dispersion is considered to be phase stable if there is no visible sedimentation present at the conclusion of the indicated time.

An advantage of the invention is that significant improvement in phase stability is achieved without significant increase in viscosity. A drop in viscosity is often seen after the shearing step. Preferably, the viscosity of the stabilized recyclate polyol dispersion is no greater than that of the starting recyclate polyol dispersion, when measured using a 25 mm parallel plate rheometer with a gap of 1.2 mm at 25° C. and a shear rate of 0.1 sec-1. More preferably, the viscosity of the stabilized recyclate polyol dispersion is no more than 0.85 times, or no more than 0.75 times, that of the starting recyclate polyol dispersion. In absolute terms, the viscosity of the stabilized recyclate polyol dispersion in some embodiments as measured under the aforementioned conditions is no greater than 20 Pa·s, no more than 15 Pa·s, or no more than 10 Pa·s.

The stabilized recyclate polyol dispersion is useful for making polyurethanes of various types, in particular rigid, semi-rigid, and/or flexible polyurethane foams, by reaction with a polyisocyanate. In general, the stabilized recyclate polyol dispersion and polyisocyanate are combined to form a reaction mixture that is then cured to form the polyurethane. Curing is typically spontaneous, even when the stabilized recyclate polyol dispersion and polyisocyanate are combined at about room temperature. However, catalysts and/or elevated curing temperatures may be used to adjust the curing rate if desired. Curing may be performed in a mold; polyurethane foam can be made if desired in a free-rise process in which the foam formulation is dispensed into an open trough or box and allowed to rise without vertical constraint. Various other ingredients may be present in the reaction mixture, including, for example:
A) additional polyols, such as polyether and/or polyester polyols, having hydroxyl numbers of 375 mg KOH/g or less and 1 to 8 hydroxyl groups per molecule;
B) short-chain polyols having 2 to 4 hydroxyl groups per molecule and hydroxyl numbers of 376 to 1870;
C) aminoalcohols such as diethanolamine, monoethanolamine and triethanolamine;
D) amine-terminated polyethers;
E) blowing agents, including chemical blowing agents such as water and physical blowing agents of various kinds;
F) catalysts, including catalysts for the reaction of an isocyanate group with an alcohol, catalysts for the reaction of an isocyanate group with water, and isocyanate trimerization catalysts;
G) surfactants, including foam-stabilizing surfactants as are useful for making polyurethane foam;
H) colorants, fillers, and other particulates;
I) reinforcing fibers;
J) preservatives such as biocides, fungicides, antioxidants;
K) “cool touch” additives such as an encapsulated phase change material; as well as other additives as may be useful for making polyurethanes of various types.

Suitable methods for making polyurethanes of various types are described, for example, in U.S. Pat. Nos. 3,632,707, 4,350,778, 7,704,410, 4,970,243, 5,157,056, 5,582,840 and 6,005,016, and U.S. Published Patent Application No. 2020/0040153, among many others. In general, the stabilized polyol dispersion of the invention may be used in the same general manner as conventional polyols of similar hydroxyl functionality and equivalent weight.

In the following examples, all parts and percentages are by weight unless otherwise indicated.

The starting recyclate polyol dispersions (RPDs) used in the following examples are produced by chemolysis (glycolysis and acidolysis) of polyurethane foam scrap according to the general method described in U.S. Pat. No. 11,224,623. The starting RPDs have a liquid polyol phase that includes virgin polyol and a recyclate polyol produced by chemolysis of the polyurethane foam scrap, and dispersed solid particles produced by chemolysis of the polyurethane foam scrap. The dispersed solid particles contain imide groups as well as urethane and/or urea groups.

The starting RPD used in Comparative Sample A and Examples 1-7 contains 13.5% by weight dispersed particles. It has a density of approximately 1100 kg/m³. To produce Comparative Sample A, a portion of this starting RPD is heated to 60° C. and processed through a 4″ (10.16 cm) IKA Process Pilot Mixer at a flow rate of 50 g/minute without applying shear. Examples 1 to 7 are prepared by processing a portion of the starting RPD through the same mixer at 60° C., at flow rates and rotational speeds as indicated in Table 3, to produce shear rates and shear work also as indicated in Table 3.

The IKA Process Pilot Mixer is equipped with 3 mixer stages (generators), each with multiple rotor/stator rows and slots having the following dimensions:

TABLE 1
Rotor/Stator Geometry

| | | Rotor | | | | | Total |
|---|---|---|---|---|---|---|---|
| | | Diam- | Shear | | Slot | Slot | Slot |
| Mixer | | eter, | Gap, | # | Height, | Width, | Volume, |
| Stage | Row | m | m | Slots | mm | mm | mm³ |
| 1 | 1 | 0.047 | 0.0005 | 9 | 3.5 | 1.575 | 24.81 |
| 1 | 2 | 0.057 | 0.0005 | 9 | 3.5 | 1.575 | 24.81 |
| 2 | 1 | 0.037 | 0.0005 | 13 | 3.5 | 0.965 | 21.95 |
| 2 | 2 | 0.047 | 0.0005 | 13 | 3.5 | 0.965 | 21.95 |
| 2 | 3 | 0.057 | 0.0005 | 13 | 3.5 | 0.964 | 21.95 |
| 3 | 1 | 0.0345 | 0.0005 | 22 | 3.5 | 0.72 | 27.72 |
| 3 | 2 | 0.043 | 0.0005 | 22 | 3.5 | 0.72 | 27.72 |
| 3 | 3 | 0.052 | 0.0005 | 22 | 3.5 | 0.72 | 27.72 |
| 3 | 4 | 0.060 | 0.0005 | 22 | 3.5 | 0.72 | 27.72 |

The residence time in each row of the rotor/stator is calculated as the total slot volume divided by the flow rate in mm³/s. The rotor tip speed in m/s is calculated as π×rotor diameter×rotations per second. Shear rate in each row is calculated as rotor tip speed divided by the shear gap. Shear work in each row is calculated as shear rate×residence time. The mean shear rate is the arithmetic mean of the shear rates in each row. The total shear work is the sum of the shear work in each row.

In Example 1, the dispersion is fed through the rotor/stator mixer at a rate of 50 g/minute, or 759.6 mm³/s. The rotational speed of the rotor is 1174 rpm, or 19.57 revolutions/second. The shear rates and shear work in the various rows are as follow:

TABLE 2
Example 1 Shear Rate and Shear Work per Row

| | | Tip | | |
|---|---|---|---|---|
| | Residence | Speed, | Shear | Shear |
| Level/Row | time, s | m/s | Rate, s⁻¹ | Work |
| 1/1 | 0.0327 | 2.9 | 5778 | 188.7 |
| 1/2 | 0.0327 | 3.5 | 7008 | 228.8 |
| 2/1 | 0.0289 | 2.3 | 4549 | 131.5 |
| 2/2 | 0.0289 | 2.9 | 5778 | 167.0 |
| 2/3 | 0.0289 | 3.5 | 7008 | 202.5 |
| 3/1 | 0.0365 | 2.1 | 4242 | 154.8 |
| 3/2 | 0.0365 | 2.6 | 5285 | 192.9 |
| 3/3 | 0.0365 | 3.2 | 6393 | 233.3 |
| 3/4 | 0.0365 | 3.7 | 7376 | 269.2 |

| Mean Shear Rate | 5935 | s⁻¹ |
|---|---|---|
| Total Shear Work | 1769 | |
| Total Residence Time | 0.298 | s |

In the same manner, minimum, mean and peak shear rates are determined for each of Examples 1-7. The Lumisizer Instability Index is determined for each of Examples 1-7 (and for Comparative Sample A) in the manner described by ISO 13318-2 (2007). In addition, phase stability is evaluated subjectively by placing samples into closed clear containers and allowing the containers to sit quiescently at 20-25° C. for 3 months. The aged samples are inspected visually to see whether particle sedimentation has taken place. Results are as indicated in Table 3.

TABLE 3

| | | Rotor | | | | | | |
|---|---|---|---|---|---|---|---|---|
| | Flow rate, | Speed, | Shear Rate, s⁻¹ | | | Shear | Instability | Phase |
| Sample | mm³/s | s⁻¹ | Minimum | Mean | Peak | Work | Index | Stability |
| A* | 759.6 | 0 | 0 | 0 | 0 | 0 | 0.083 | <1 |
| | | | | | | | | month |
| 1 | 759.6 | 1174 | 4241 | 5935 | 7376 | 1769 | 0.051 | >3 |
| | | | | | | | | months |
| 2 | 759.6 | 2051 | 7410 | 10369 | 12887 | 3090 | 0.043 | >3 |
| | | | | | | | | months |
| 3 | 759.6 | 3094 | 11178 | 15642 | 19440 | 4661 | 0.045 | >3 |
| | | | | | | | | months |
| 4 | 759.6 | 5056 | 18266 | 25561 | 31768 | 7617 | 0.039 | >3 |
| | | | | | | | | months |
| 5 | 759.6 | 7695 | 27801 | 38903 | 48349 | 11592 | 0.034 | >3 |
| | | | | | | | | months |
| 6 | 1899 | 3094 | 11178 | 15642 | 19440 | 1864 | 0.049 | >3 |
| | | | | | | | | months |
| 7 | 1899 | 7690 | 27783 | 38878 | 48318 | 4634 | 0.038 | >3 |
| | | | | | | | | months |

*Not an example of the invention.

The starting RPD used in Comparative Samples B-D and Example 8 contains 16.8% by weight dispersed particles. It has a density of approximately 1100 kg/m³. To produce Comparative Sample B, a portion of this starting RPD is heated to 60° C. and pushed through the same rotor/stator mixer at a flow rate of 50 g/minute without applying shear. Comparative Samples C and D and Example 8 are prepared by passing the same starting RPD through the same mixer at 60° C., at flow rates at rotor/stator rotational rates as indicated in Table 4.

TABLE 4

| | | Rotor | | | | | | |
|---|---|---|---|---|---|---|---|---|
| | Flow rate, | Speed, | Shear Rate, s⁻¹ | | | Shear | Instability | Storage |
| Sample | mm³/s | s⁻¹ | Minimum | Mean | Peak | Work | Index | Stability |
| B* | 759.6 | 0 | 0 | 0 | 0 | 0 | 0.074 | <1 month |
| C* | 759.6 | 799 | 2887 | 4038 | 5020 | 1204 | 0.062 | <1 month |
| D* | 1929 | 1021 | 3689 | 5162 | 6415 | 606 | 0.061 | <1 month |
| 8 | 729.3 | 7721 | 27895 | 39035 | 48512 | 12116 | 0.037 | >1 month |

*Not an example of the invention.

The viscosity of certain of the processed RPD's are measured using a 25 mm parallel plate rheometer with a gap of 1.2 mm at 25° C., at shear rates of 0.1 s−¹ and 100 s⁻¹. Results are as indicated in Table 5.

TABLE 5

Viscosity, Pa · s

| Sample | 0.1 s⁻¹ | 100 s⁻¹ |
|---|---|---|
| A* | 16 | 4.7 |
| 5 | 9.7 | 4.2 |
| B* | 6.1 | 5.1 |
| C* | 5.1 | 5.0 |
| D* | 4.0 | 4.2 |
| 8 | 6.0 | 5.6 |

*Not an example of the invention.

The particle sizes of Comparative Samples A-D and Examples 1-8 are measured using a Beckman Coulter LS 13 320 Laser Diffraction Particle Size Analyzer. Particle size measurements were made by first diluting the sample in isopropanol. D10, D90, D32 and D43 particle sizes are as indicated in Table 6. A D10 particle size of X indicates that 10 volume percent of the particles have particle sizes equal to or smaller than X. The D32 particle size is the Sauter mean diameter; the D43 is the De Broukere mean.

TABLE 6

| | D10, | D90, | D32, | D43, |
|---|---|---|---|---|
| Designation | μm | μm | μm | μm |
| A* | 2.90 | 40.1 | 35.1 | 37.7 |
| 1 | 1.97 | 36.4 | 32.4 | 35.3 |
| 2 | 1.81 | 32.3 | 29.6 | 32.9 |
| 3 | 1.62 | 20.6 | 23.3 | 27.5 |
| 4 | 1.71 | 25.5 | 26.2 | 30.0 |
| 5 | 1.82 | 16.9 | 17.7 | 20.9 |
| 6 | 1.83 | 30.5 | 28.8 | 32.6 |
| 7 | 1.99 | 32.8 | 30.0 | 33.3 |
| B* | 2.17 | 37.6 | 33.8 | 36.1 |
| C* | 2.20 | 35.8 | 31.9 | 34.4 |
| D* | 2.08 | 35.1 | 31.5 | 34.2 |
| 8 | 1.57 | 31.1 | 28.4 | 31.0 |

*Not an example of this invention.

1. A method for stabilizing a starting recyclate polyol dispersion that exhibits a Lumisizer Instability Index of at least 0.60, comprising shearing the starting recyclate polyol dispersion at a mean shear rate of at least 5,500/s for a period of time sufficient to produce a stabilized recyclate polyol dispersion exhibiting a Lumisizer Instability Index of at most 0.55.

2. A method for stabilizing a starting recyclate polyol dispersion that exhibits a Lumisizer Instability Index of at least 0.60, comprising shearing the starting recyclate polyol dispersion for a period of time of from 0.05 to 5 seconds at a mean shear rate of at least 5,500/s.

3. The method of claim 1, wherein a minimum shear rate during the shearing is at least 3,000/s.

4. The method of claim 1, wherein the mean shear rate is from 10,000/s to 50,000/s.

5. The method of claim 1, wherein the shearing is continued for a period of time of from 0.05 to 5 seconds.

6. The method of claim 5, wherein the shearing is continued for a period of time of from 0.1 to 1 second(s).

7. The method of claim 1, wherein the shearing is continued for a period of time sufficient to produce a stabilized recyclate polyol dispersion exhibiting a Lumisizer Instability Index of at most 0.45.

8. The method of claim 1, wherein shear work of from 1,200 to 50,000 is performed during the shearing.

9. The method of claim 8, wherein shear work of from 1,500 to 12,000 is performed during the shearing.

10. The method of claim 1, wherein the shearing is performed in the absence of fumed silica having a methanol wettability of from 10% to 60%.

11. A method for stabilizing a starting recyclate polyol dispersion that exhibits a Lumisizer Instability Index of at least 0.60, comprising shearing the starting recyclate polyol dispersion in a shearing apparatus under conditions that provide at least 104 watts of power per kg of the starting recyclate material, for a period of time sufficient to produce a stabilized recyclate polyol dispersion exhibiting a Lumisizer Instability Index of at most 0.55.

12. The method of claim 11, wherein the starting recyclate polyol dispersion comprises a continuous liquid phase comprising a recyclate polyol produced by chemolysis of a solid polyurethane and/or polyurethane-urea; and solid particles dispersed in the continuous liquid phase, wherein the particles are insoluble in the continuous liquid phase and contain one or more urethane, urea and/or imide groups, the particles being formed by chemolysis of the solid polyurethane and/or polyurethane-urea.

13. The method of claim 12, wherein the starting recyclate polyol is produced by reacting a polyurethane and/or polyurea polymer with an imide precursor and a polyether polyol having a number average molecular weight of from 400 to 6,000 g/mol and a hydroxyl functionality of from 2 to 4 in a first reaction step, and then with a diol or triol having a formula molecular weight of up to 250 g/mol in a second reaction step to produce the starting recyclate polyol dispersion.

14. The method of claim 1, wherein the starting recyclate polyol dispersion comprises a continuous liquid phase comprising a recyclate polyol produced by chemolysis of a solid polyurethane and/or polyurethane-urea; and solid particles dispersed in the continuous liquid phase, wherein the particles are insoluble in the continuous liquid phase and contain one or more urethane, urea and/or imide groups, the particles being formed by chemolysis of the solid polyurethane and/or polyurethane-urea.

15. The method of claim 14, wherein the starting recyclate polyol is produced by reacting a polyurethane and/or polyurea polymer with an imide precursor and a polyether polyol having a number average molecular weight of from 400 to 6,000 g/mol and a hydroxyl functionality of from 2 to 4 in a first reaction step, and then with a diol or triol having a formula molecular weight of up to 250 g/mol in a second reaction step to produce the starting recyclate polyol dispersion.
